(19) United States
(12) Patent Application Publication
(10) Pub. No.: US 2026/0246285 A1
(43) Pub. Date: Aug. 20, 2026

(54) CONFIGURABLE COMMUNICATION SYSTEM FOR BATTERY MANAGEMENT

(71) Applicant: STMicroelectronics International N.V., Geneva (CH)

(72) Inventor: Daniele Oreggia, Sedriano (IT)

(21) Appl. No.: 19/055,353

(22) Filed: Feb. 17, 2025

(51) Int. Cl. H02J 7/40; H02J 7/50; H02J 7/84; H02J 105/37

(52) U.S. Cl. CPC H02J 7/40; H02J 7/50; H02J 7/84; H02J 2105/37

(57) ABSTRACT

According to an embodiment, a configurable communication system for battery management includes a microcontroller, transceivers, and battery management front-end circuits coupled through isolated vertical interfaces. A register map in each front-end circuit organizes monitoring data into logical blocks, such as configuration, measurement, diagnostic, and First-In-First-Out (FIFO) registers. A configurable burst command includes width and offsets parameters that specify which portion of the register map to access. The width parameter determines how many consecutive registers to read, while the offset parameter indicates the starting address. This approach replaces multiple predefined burst commands with a single flexible command that can access any sequential block of registers. The configurable nature allows dynamic adjustment of register access based on operating conditions.

### TECHNICAL FIELD

The present disclosure generally relates to electronic systems and, in particular embodiments, to a configurable communication system for battery management.

### BACKGROUND

Battery Management Systems (BMS) in automotive applications monitor and control battery packs (e.g., lithium-ion battery packs) installed in hybrid and full electric vehicles. Due to technology limitations related to supply voltages, each BMS front-end circuit manages a limited number of cells (e.g., up to 18 cells).

The BMS front-end circuits are physically located near their respective battery pack sections throughout the vehicle. These installations mean individual BMS front-end circuits may be separated by distances up to 10 meters from each other. Since each BMS front-end circuit operates at different voltage domains due to being powered by their local battery sections, traditional Serial Peripheral Interface (SPI) communication cannot be used directly between components.

Typically, an isolated communication interface is used for data exchange between BMS front-end circuits operating at different voltage levels and across boards. The interface utilizes differential signaling over twisted-pair wires with transformer or capacitor-based isolation barriers between voltage domains. This isolated interface includes two main signals: a positive differential input/output and a negative differential input/output.

The battery management architecture follows a daisy-chain configuration, with voltage monitoring BMS front-end circuits arranged in series, while current monitoring BMS front-end circuits are typically located near the BMS Electronic Control Unit (ECU). The BMS ECU coordinates the overall battery management functions by gathering voltage measurements, current measurements, and temperature readings through General Purpose Input/Output (GPIO) pins used for monitoring battery temperature.

The communication protocol between components includes mechanisms for command addressing, data transfer, and error checking through Cyclic Redundancy Check (CRC) to maintain data integrity. The protocol operates in a half-duplex manner, where a single frame reserves the communication line for the duration of the transfer.

### SUMMARY

Technical advantages are generally achieved by embodiments of this disclosure, which describe a configurable communication system for battery management.

A first aspect relates to a method, comprising receiving, at a transceiver, a frame structure from a microcontroller, the frame structure including a header field and a data field, wherein the data field includes a width field and an offset field; identifying, by the transceiver, a burst command through the header field; configuring, based on the burst command, a multiplexer to select between a single address mode and a burst mode; generating a burst address signal based on the width field and the offset field; sequentially accessing, through the multiplexer, a subset of registers defined by the width field and offset field; and transmitting data stored in the subset of registers through an isolated interface to the transceiver.

A second aspect relates to a system, comprising a microcontroller; a transceiver coupled to the microcontroller; a battery management front-end circuit; a vertical interface coupling the transceiver to the battery management front-end circuit through isolation barriers; and a register map in the battery management front-end circuit, wherein the register map is accessible through a configurable burst command, the configurable burst command comprising a width field specifying a number of consecutive registers to read and an offset field specifying a starting address for the consecutive registers.

A third aspect relates to an electric vehicle, comprising a battery pack including multiple cell groups; a plurality of battery management front-end circuits, each battery management front-end circuit configured to monitor a respective cell group; and a battery management system electronic control unit (ECU) coupled to each of the battery management front-end circuits through isolated vertical interfaces, the battery management system ECU including a microcontroller, and a transceiver configured to translate microcontroller commands into vertical interface protocol commands, and receive responses from the battery management front-end circuits, wherein the battery management system ECU is configured to access register data from the battery management front-end circuits using a configurable burst command that specifies a width parameter and an offset parameter for defining register subsets.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a block diagram of a battery management system;

FIG. 2 is a standard frame structure of the Vertical Interface (VIF) protocol used for communication between the BMS ECU (primary circuit) and BMS front-end circuits (auxiliary circuits) through the vertical interfaces;

FIG. 3 is a timing diagram showing the sequence of communications between components in a conventional read operation;

FIG. 4 is an embodiment frame structure for a Serial Peripheral Interface (SPI) burst command;

FIG. 5 is a timing diagram showing the sequence of communications between components in a read operation implementing the configurable frame structure;

FIG. 6 is an example register map of a device in the Vertical Interface (VIF) protocol, organizing memory into functional blocks across 2^{N} total registers;

FIG. 7 is an embodiment circuit of a configurable burst command system; and

FIG. 8 is a flowchart of an embodiment method for implementing a configurable burst command operation in a battery management system.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of battery management systems for automotive applications, it should also be appreciated that these inventive aspects may also apply to other systems utilizing the Vertical Interface (VIF) protocol for isolated communication. In particular, aspects of this disclosure may similarly apply to any system requiring configurable multi-frame burst communications between devices operating across different voltage domains.

Aspects of the disclosure provide a communication system that optimizes data transfer between battery monitoring devices operating across isolated voltage domains. A register map architecture organizes monitoring data into logical blocks, with configuration registers, voltage measurements, temperature readings, and diagnostic information stored in sequential address ranges. This organization enables efficient access to different data types through a configurable multi-frame burst command structure.

The communication system implements a single burst command type that includes offset and width parameters to specify which portion of the register map to access. The offset parameter determines the starting address for data collection, while the width parameter controls how many consecutive registers to read. This approach replaces multiple predefined burst commands with a single flexible command that can access any sequential block of registers.

A Vertical Interface (VIF) protocol layer carries the configurable burst communications between a BMS ECU and BMS front-end circuits arranged in a daisy-chain configuration. The protocol maintains isolated differential signaling across voltage domains while preserving error detection through Cyclic Redundancy Check (CRC) calculations. A transceiver handles protocol translation between Serial Peripheral Interface (SPI) and VIF domains.

The configurable burst mechanism reduces protocol overhead by eliminating the need for separate command addresses for different register combinations. Rather than implementing fixed burst commands in hardware for voltage measurements, temperature readings, or diagnostics, the system can dynamically adjust the offset and width parameters to collect exactly the required data. This flexibility allows the communication system to adapt to different monitoring scenarios while maintaining efficient bandwidth utilization.

For advanced battery monitoring algorithms, the system can modify burst parameters based on operating conditions. For example, when monitoring battery State of Health (SoH), the offset and width values can be adjusted to capture specific combinations of voltage and current measurements during cell excitation periods. The width parameter may be increased to collect more diagnostic data when temperature or voltage measurements indicate potential issues.

A First-In-First-Out (FIFO) memory structure can be mapped to addresses beyond the main register map, allowing the same configurable burst mechanism to efficiently access sequences of buffered measurements. This capability supports applications requiring collection and analysis of measurement trends over time without implementing additional command types.

The communication system maintains backward compatibility with existing protocols while reducing digital logic complexity compared to implementing multiple fixed burst commands. The configurable approach provides flexibility for future monitoring requirements without requiring protocol modifications or additional command address space. These and additional details are further discussed below.

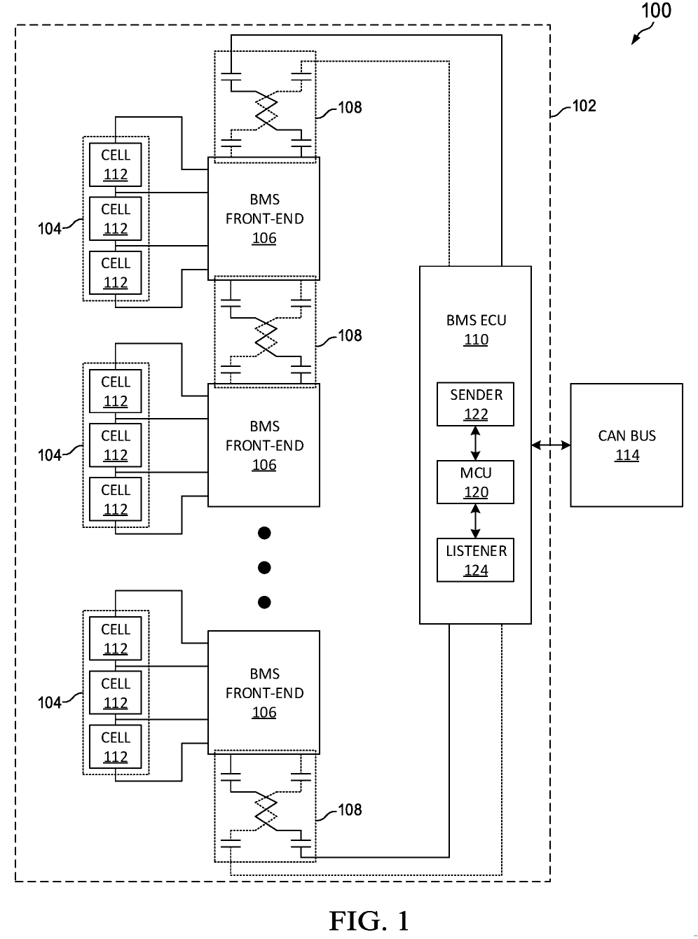

FIG. 1 illustrates a block diagram of a battery management system 100, which may be incorporated within an electric vehicle. The battery management system 100 includes a battery pack 102 coupled to a Controller Area Network (CAN) bus 114. The battery pack 102 includes multiple cell groups 104, each containing multiple individual cells 112. Battery Management System (BMS) front-end circuits 106 monitors these cell groups, with the system controlled by a BMS Electronic Control Unit (ECU) 110.

While three individual cells 112 are shown in each cell group 104 and three BMS front-end circuits 106 are illustrated, this configuration is non-limiting. Fewer or greater numbers of cells and front-end circuits are contemplated in various embodiments. Further, battery management system 100 may include additional components not shown.

The BMS ECU 110 incorporates a microcontroller (MCU) 120 that manages processing operations. A sender circuit 122 and a listener circuit 124 within the BMS ECU 110 handle communications with the BMS front-end circuits 106 through vertical interfaces 108. The microcontroller 120 communicates with the sender circuit 122 and listener circuit 124 through Serial Peripheral Interface (SPI) and Battery Network Enable (BNE) interfaces.

Vertical interfaces 108 implement an isolated communication scheme that allows components operating at different ground levels and on different boards to communicate reliably. Each vertical interface 108 utilizes twisted-pair wires with transformer isolators or capacitors to provide galvanic isolation between voltage domains. The sender circuit 122 and the listener circuit 124 couple to a positive isolation node (ISO_{P}) and a negative isolation node (ISO_{N}) of the vertical interfaces 108. The differential signal is decoded into standard SPI data format, typically received by the microcontroller 120 via a Master Out Slave In (MOSI) pin.

The BMS front-end circuits 106 are arranged in a daisy-chain configuration through the vertical interfaces 108, enabling efficient communication of cell information to the BMS ECU 110. Each BMS front-end circuit 106 captures information from its associated cell group 104, such as cell voltages, temperatures, and other parameters. The communication protocol operates in half-duplex mode, with data transmitted and received over pulse-shaped signals.

The vertical interfaces 108 include isolation components such as decoupling capacitors and resistors to maintain proper signal transmission while preserving galvanic isolation between sections. The individual cells 112 within cell groups 104 may be positioned at different physical locations throughout the electric vehicle, with varying distances between them.

The BMS ECU 110 interfaces with broader vehicle systems through the CAN bus 114, providing battery status information and receiving control commands. The modular architecture allows scalable battery pack configurations while maintaining reliable communication between distributed monitoring circuits through the isolated vertical interfaces 108.

While FIG. 1 illustrates sender circuit 122 and listener circuit 124 as separate components within BMS ECU 110, in some embodiments these circuits may be implemented as a single transceiver that handles transmission and reception of signals between the microcontroller 120 and BMS front-end circuits 106. The separate illustration of sender circuit 122 and listener circuit 124 serves to demonstrate the distinct signal paths and protocol translation functions but does not limit the physical implementation to separate circuits. Various configurations of transceivers may be employed to perform the protocol translation between SPI and VIF domains while maintaining the isolated communication capability through vertical interfaces 108.

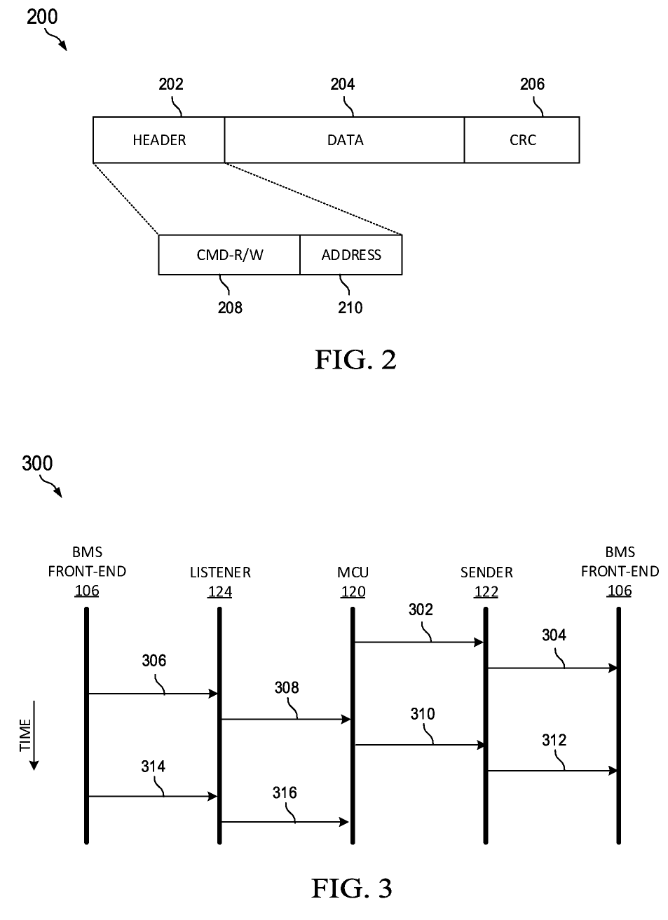

FIG. 2 illustrates a standard frame structure 200 of the Vertical Interface (VIF) protocol used for communication between the BMS ECU 110 (primary circuit) and BMS front-end circuits 106 (auxiliary circuits) through the vertical interfaces 108.

The VIF protocol implementation inherits the Serial Peripheral Interface (SPI) frame structure, and all communications are initiated by the primary circuit. The frame structure 200 includes three sections: a header field 202, a data field 204, and a Cyclic Redundancy Check (CRC) field 206. The header field 202 is further divided into two components: a command read/write (CMD-R/W) field 208 that specifies the operation type and an address field 210 that identifies the target device and register. Operating at 3.6Mbps, each 40-bit standard frame transmission completes in approximately 11 microseconds.

The CMD-R/W field 208 can be configured for three command types, with each command sequence incorporating interframe periods between transmissions to ensure proper signal separation and timing. For write operations, the primary circuit initiates by transmitting a frame, followed by an interframe period, after which the addressed auxiliary circuit may respond with an optional echo command frame for acknowledgment. The primary circuit initiates for read operations by sending a read command frame, followed by an interframe period. The addressed auxiliary circuit responds with a read answer frame containing the requested data. The burst command configuration provides more efficient multiple read answers after a single command, particularly beneficial for voltage cells readout, to increase effective bits data rate. These burst responses are separated by interframe periods between the initial command and each subsequent response frame.

The protocol implements half-duplex communication, where a single frame reserves the line for its duration. This means the vertical interface 108 communication line remains reserved for the duration of any frame transmission and its associated interframe periods. During these times, no other communication can occur on that line, whether it's a command from the BMS ECU 110 to a BMS front-end circuit 106 or a response in the opposite direction. Each read command is followed by the answer of the addressed auxiliary circuit, maintaining an organized communication flow.

The frame structure 200 supports the isolated communication scheme that allows components at different ground levels and on different boards to communicate with each other. The isolated VIF protocol is versatile, allowing the implementation of additional protocol layers to increase the effective data rate to better support application requirements. The CRC field 206 provides error detection capabilities to ensure data integrity across the isolated interface, which can be advantageous given the potentially noisy automotive environment and varying distances between components.

Each command type (write, read, burst) utilizes the frame structure 200, with the CMD-R/W field 208 and subsequent protocol sequence, including appropriate interframe periods, differentiating the operation. This standardized approach simplifies protocol implementation while maintaining flexibility for different types of data transfer operations between the primary and auxiliary circuits, all while preserving the inherited SPI frame structure and primary circuit-initiated communication model.

FIG. 3 illustrates a timing diagram 300 showing the sequence of communications between components in a conventional read operation. The diagram demonstrates how data rate optimization matches 10ms system requirements for all measurement readings, as detailed in United States Patent No. 12,056,080, which is incorporated herein by reference in its entirety.

Conventional solutions employ fixed register map subsets for multi-frame burst operations, triggering each subset with a specific address. This approach results in inefficient address space utilization, as each predefined burst command requires its dedicated address. For example, typical implementations include hardwired burst commands in the silicon: burst command 1 for voltage measurements (e.g., accessing addresses X to Y), burst command 2 for temperature measurements (e.g., accessing addresses K to J), and burst command 3 for diagnostics (e.g., accessing addresses I to M). This rigid structure lacks configurability and adaptability, as there is no possibility to read partial subsets without implementing additional command addresses.

While compressed burst capabilities provide Analog-to-Digital Converter (ADC) data rate optimization, additional timing optimizations may be implemented for specific application scenarios. These scenarios can include reading only part of the measurements, reading all diagnostic registers or a subset, and checking configuration status.

In the timing diagram, all Vertical Interface (VIF) communications are initiated by the microcontroller 120, with translations between Serial Peripheral Interface (SPI) and VIF protocols handled by the sender circuit 122 and listener circuit 124 circuits (transceivers). The sender circuit 122 is inserted between the BMS ECU 110 and the BMS front-end circuits 106 to translate SPI to VIF protocols.

An SPI request frame is required for each answer received, which must be translated for VIF protocol by the listener circuit 124 when communicated to the microcontroller 120. When reading a register map subset, each read command must be propagated along the VIF, demonstrating the time overhead of single VIF accesses in conventional implementations.

The sequence begins with signal 302, where microcontroller 120 sends an SPI read command 1 to the sender circuit 122. The sender circuit 122 translates this to a VIF read command 1, shown as signal 304, and transmits it to the BMS front-end circuit 106.

The BMS front-end circuit 106 responds with signal 306, sending a VIF read answer 1 to the listener circuit 124. The listener circuit 124 then translates this response back to SPI format and forwards it to microcontroller 120 via signal 308, completing the first read cycle.

A second read cycle follows, beginning with signal 310, where microcontroller 120 sends an SPI read command 2 to sender circuit 122. The sender circuit 122 translates and forwards this as VIF read command 2 via signal 312 to the BMS front-end circuit 106. The response follows the same path back, with signal 314 carrying the VIF read answer 2 from the BMS front-end circuit 106 to listener circuit 124, and finally, signal 316 delivering the translated SPI read answer 2 to microcontroller 120.

This sequence demonstrates how reading a register map subset requires multiple command-response cycles, with each read command propagating along the VIF communication path and requiring protocol translation at both ends. The timing diagram emphasizes the overhead introduced by multiple protocol translations and separate read commands for each data request.

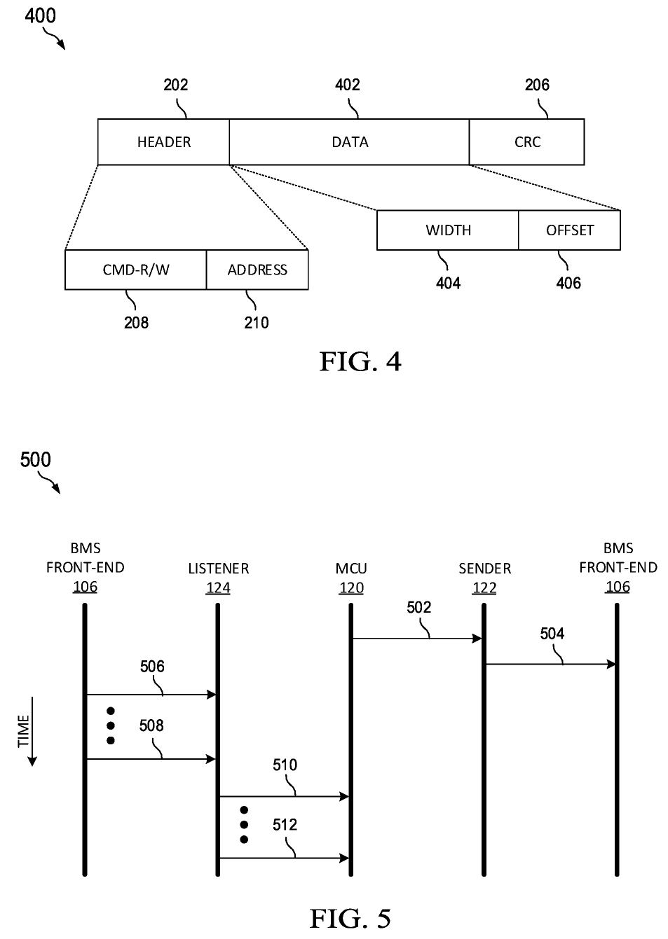

FIG. 4 illustrates an embodiment frame structure 400 for a Serial Peripheral Interface (SPI) burst command. The data field 402 introduces configurability through two components: a width field 404 and an offset field 406. While shown in a particular arrangement, these fields may be organized differently, such as in reverse order, in various embodiments.

This frame structure 400 implements a configurable multi-frame burst command where the offset field 406 determines the starting address and the width field 404 specifies the subset depth when sending the command. This configuration allows the command signal to dynamically select which register map subset to read via Vertical Interface (VIF) during each transmission. In some embodiments, this functionality may be implemented through dedicated commands for each subset.

Unlike the conventional approach shown in FIG. 3, which requires multiple SPI signals (such as signals 302 and 310) each requiring translation by sender circuit 122, the configurable burst command enables a single read command signal. The response includes multiple answers (e.g., N answers, where N represents an integer greater than 0) defined by the configurable register map subset. These are communicated once to the microcontroller 120 for reading. This approach eliminates the need for multiple translations and separate command signals, streamlining communication.

The burst command recognition occurs through the header field 202, while the data field 402 defines the specific register map subset to access. Each address field 210 maps to a register containing dedicated fields, with registers organized into categories to create logical subsets within the map. For example, registers may be grouped by function, such as configuration, normal operation, ADC measurements, diagnostics, voltage/current measurements, and temperature readings.

In embodiments, the architecture supports First-In-First-Out (FIFO) implementation by utilizing the same address map as the register map for consistent data addressing via the communication protocol but without requiring one-to-one correspondence. For example, a cell measurement may be stored in different locations based on the sampling sequence. This flexibility in the FIFO implementation allows for efficient data storage and retrieval while maintaining the benefits of the configurable burst command structure.

The configurable nature of the burst command through the width field 404 and offset field 406 provides significant advantages over conventional fixed burst commands, allowing dynamic adaptation to different monitoring scenarios while maintaining efficient protocol operation.

FIG. 5 illustrates a timing diagram 500 showing the sequence of communications between components in a read operation implementing the configurable frame structure detailed in FIG. 4. The sequence demonstrates how a single burst command can efficiently retrieve multiple register values, presenting a significant improvement over the conventional approach shown in FIG. 3.

The communication begins with signal 502, where microcontroller 120 sends a single SPI burst command to sender circuit 122. This command, structured according to frame structure 400, includes the width field 404 and offset field 406 that define which register map subset to access. This represents a difference from FIG. 3, where multiple SPI read command signals are required for accessing different registers. The sender circuit 122 translates this single burst command into a VIF burst command, shown as signal 504, and transmits it to the X^{th} BMS front-end circuit.

In response to the burst command, the X^{th} BMS front-end circuit sends multiple VIF read answers to listener circuit 124, represented by signals 506 through 508. While the diagram shows two response signals for clarity, the actual number of responses corresponds to N, where N is specified by the burst width parameter in the original command. These signals collectively form a multi-frame burst containing the requested register map subset. This contrasts with FIG. 3, where each read answer required a preceding read command and translation cycle.

The listener circuit 124 processes these N responses and communicates them to the microcontroller 120 through signals 510 through 512. The number of signals from listener circuit 124 to microcontroller 120 matches one-to-one with the N answers received from the BMS front-end circuit 106, though only two are shown in the diagram for simplicity. Unlike FIG. 3, where each response is tied to a separate command cycle, these responses all result from a single configurable burst command.

This timing diagram 500 illustrates the efficiency gained through the multi-frame burst sequence, where microcontroller 120 can request N registers from the X^{th} BMS front-end circuit along the VIF using a single configurable burst command. The approach eliminates the need for multiple SPI command translations seen in FIG. 3 (signals 302 to 304 and 310 to 312), reducing protocol overhead and improving communication efficiency. Using the configurable width and offset parameters, the system can dynamically adjust which register map subset to read, providing flexibility not available in the conventional fixed-command approach of FIG. 3.

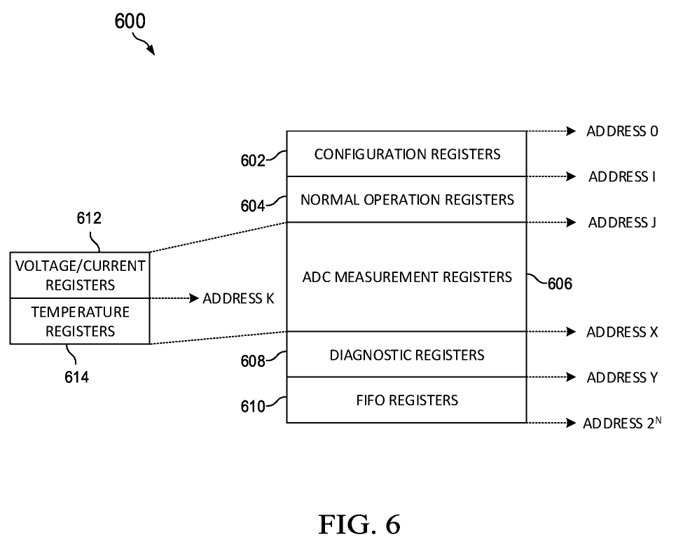

FIG. 6 illustrates an example register map 600 of a device in the Vertical Interface (VIF) protocol, organizing memory into functional blocks across 2^{N} total registers. Each address corresponds to a register where dedicated fields are located, with registers split according to category to create logical subsets within the map.

The register map 600 includes configuration registers 602 (addresses 0 to I), which store device setup parameters and operating modes. Normal operation registers 604 (addresses I to J) maintain current operating status and control settings.

The ADC measurement registers 606 span from address J to X and are subdivided into two categories: voltage/current registers 612 (addresses J to K) storing battery cell voltage measurements and current sensor readings, and temperature registers 614 (addresses K to X) containing temperature measurements from various monitoring points. Diagnostic registers 608 (addresses X to Y) store system health information, error flags, and status indicators. A First-In-First-Out (FIFO) registers 610, used specifically for State of Health (SOH) monitoring, occupies addresses Y through 2^{N}.

The FIFO implementation exploits the same address map as the register map for consistent data addressing via the communication protocol but without requiring one-to-one correspondence. For example, a cell measurement may be stored in different FIFO locations according to the sampling sequence. This flexible storage approach allows measurement data to be organized based on sampling order rather than fixed register assignments.

The configurable burst command enables flexible access to these register blocks through offset and width parameters. For example, configuration registers 602 can be accessed by setting the offset field 406 equal to ‘0’ and setting the width field 404 equal to ‘I-1’, while ADC measurement registers 606 can be read by setting the offset field 406 equal to ‘J’ and setting the width field 404 equal to ‘X-J-1’. Diagnostic registers 608 are accessible by setting the offset field 406 equal to ‘X’ and setting the width field 404 equal to ‘Y-X-1’, and FIFO registers 610 can be read by setting the offset field 406 equal to ‘Y’ and setting the width field 404 equal to ‘2^{N}-Y-1’.

This organization allows multiple possibilities for reading register map or FIFO subsets with a single burst command by adjusting the offset and width parameters, providing efficient access to any portion of the register map while maintaining logical grouping of related data.

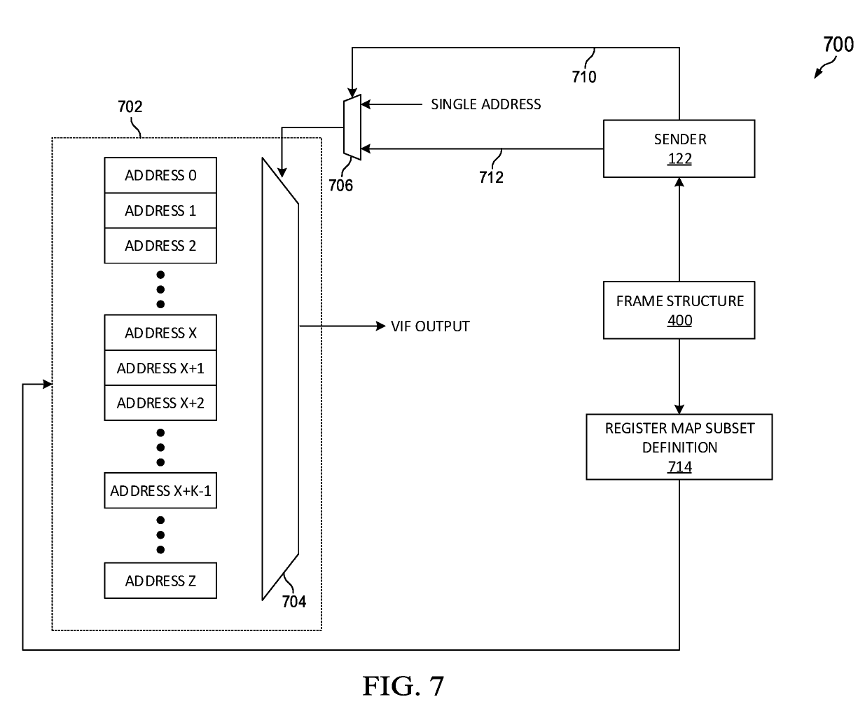

FIG. 7 illustrates an embodiment circuit 700 of a configurable burst command system. A register map 702, which may be implemented according to the organization shown in register map 600 of FIG. 6, contains addresses ranging from ‘0’ to ‘Z’. In embodiments, these addresses store various types of data, including configuration settings, measurements, diagnostics, and FIFO data.

A first multiplexer 704 provides the Vertical Interface (VIF) output by selecting data from the register map 702. The selection control for the first multiplexer 704 comes from a second multiplexer 706, which manages address selection based on the operation mode. The second multiplexer 706 has two inputs: one for receiving a single address signal for conventional operations and another for receiving a burst address signal 712 for burst mode operations.

The frame structure 400 defines the command type through its header field 202 and the register map subset definition 714 through its width field 404 and offset field 406 parameters. When the sender circuit 122 recognizes a burst command through the header field 202, it generates a burst command signal 710 to configure the second multiplexer 706 to select the burst address signal 712 instead of the single address input. The burst address signal 712 then sequences through the addresses defined by the offset field 406 and width field 404 parameters from the register map subset definition 714.

In the illustrated example, when the offset field 406 is set to ‘X’ and the width field 404 is set to ‘K’, the system will access ‘K’ consecutive registers starting from address ‘X’. This means the burst operation will sequentially read registers from address ‘X’ through address ‘X+K-1’, as shown in register map 702.

The first multiplexer 704 facilitates this sequential access by selecting each addressed register in sequence, providing the requested data to the VIF output. This architecture enables efficient access to consecutive registers without requiring multiple command frames while maintaining the ability to perform conventional single-address operations through the same hardware infrastructure.

The configurable burst command architecture provides several advantages over conventional implementations. Utilizing a single configurable command structure with width field 404 and offset field 406 parameters reduces the digital logic area that would otherwise be required for implementing multiple fixed burst commands. This simplified multiplexing approach eliminates the need for separate command detection and handling circuits for each type of burst operation.

Address space efficiency is significantly improved as the system no longer requires dedicated command addresses for different burst operations. Instead of allocating separate addresses for voltage measurements, temperature readings, diagnostics, and other data subsets, a single burst command address can be used with the offset field 406 and width field 404 to determine which registers to access. This preservation of address space becomes particularly valuable in systems with limited address ranges.

The architecture provides enhanced support for future Electrochemical Impedance Spectroscopy (EIS) implementations by enabling rapid access to voltage-current First-In-First-Out (FIFO) subsets. These FIFO registers store sequences of voltage and current samples that are essential for measuring cell impedance as part of State of Health (SoH) algorithms. The configurable burst command allows quick retrieval of these measurement sequences through appropriate offset field 406 and width field 404 settings, facilitating efficient implementation of advanced battery monitoring algorithms without requiring protocol modifications or additional command types.

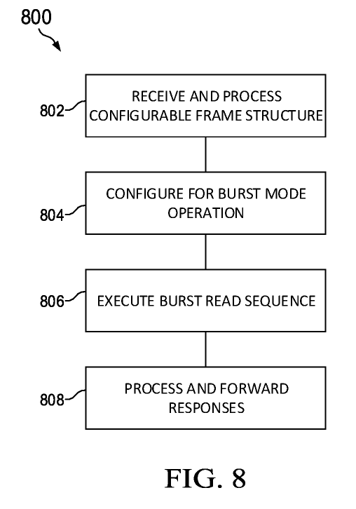

FIG. 8 illustrates a flowchart of an embodiment method 800 for implementing a configurable burst command operation in a battery management system. Method 800 provides efficient access to register map subsets through a simplified command structure that reduces digital logic area and address space utilization compared to conventional fixed burst commands.

Method 800 demonstrates how the configurable burst command structure streamlines data access compared to conventional approaches requiring multiple command-response cycles. While specific steps are shown, variations in the sequence and implementation of these steps may be possible in different embodiments. The method provides flexibility for future monitoring requirements without requiring protocol modifications or additional command address space.

It is noted that all steps outlined in the method are not necessarily required and can be optional. Further, changes to the arrangement of the steps, removal of one or more steps and path connections, and addition of steps and path connections are similarly contemplated.

At step 802, a transceiver (e.g., the sender circuit 122) receives and processes a frame structure (e.g., the frame structure 400) from a microcontroller (e.g., the microcontroller 120). During this step, the transceiver identifies a burst command through the header field of the frame structure and extracts the width field and offset field parameters from the data field of the frame structure. These parameters define which portion of the register map will be accessed during the burst operation.

For example, to read configuration registers, the offset field and the width field are set to the address range of the configuration registers. Similarly, for ADC measurement registers, the offset field and the width field are set to the address range of the ADC measurement registers. This flexibility allows access to any register subset, such as diagnostic and FIFO registers, by setting the offset and width fields through the frame structure.

At step 804, the system configures for burst mode operation based on the structured register map organization. The transceiver generates a burst command signal to configure multiplexers for burst mode instead of a single address operation. A burst address signal is generated based on the extracted offset and width parameters, establishing the register map subset definition, which may be dynamically adjusted based on operating conditions. For example, if temperature readings exceed certain thresholds, the width parameter may be increased to collect additional diagnostic data.

This configuration supports standard register map access and FIFO implementations, where measurements may be stored in different locations according to sampling sequence. The step enables efficient access to various data types, including voltage/current measurements, temperature readings, diagnostics, and State of Health (SOH) monitoring data.

At step 806, the system executes the burst read sequence. The multiplexer sequentially accesses consecutive registers as the offset and width parameters specify. The accessed register data is transmitted through the VIF interface using differential signaling over an isolated interface, with N response frames generated based on the width parameter.

Each frame transmission can include appropriate interframe periods to ensure proper signal separation and timing. This consolidated burst operation eliminates the need for multiple individual read commands and their associated protocol translations, significantly improving communication efficiency compared to the conventional approach shown in FIG. 3.

At step 808, the system processes and forwards the responses. The transceiver (e.g., listener circuit 124) receives the multiple read answers through the isolated interface, translates them from VIF protocol to SPI format, and forwards the consolidated data to the microcontroller.

This step maintains proper isolation between voltage domains while enabling efficient data collection for various monitoring scenarios. The approach can be particularly beneficial for advanced applications like Electrochemical Impedance Spectroscopy (EIS), where rapid access to voltage-current FIFO subsets is essential for measuring cell impedance as part of SoH algorithms.

A first aspect relates to a method, comprising receiving, at a transceiver, a frame structure from a microcontroller, the frame structure including a header field and a data field, wherein the data field includes a width field and an offset field; identifying, by the transceiver, a burst command through the header field; configuring, based on the burst command, a multiplexer to select between a single address mode and a burst mode; generating a burst address signal based on the width field and the offset field; sequentially accessing, through the multiplexer, a subset of registers defined by the width field and offset field; and transmitting data stored in the subset of registers through an isolated interface to the transceiver.

In a first implementation form of the method, according to the first aspect as such, the subset of registers includes configuration registers, normal operation registers, analog-to-digital converter (ADC) measurement registers, diagnostic registers, First-In-First-Out (FIFO) registers, or a combination thereof.

In a second implementation form of the method, according to the first aspect as such or any preceding implementation form of the first aspect, the method further comprising receiving multiple read answers through the isolated interface at the transceiver; translating the multiple read answers from a first protocol to a second protocol; and forwarding consolidated data to the microcontroller.

In a third implementation form of the method, according to the first aspect as such or any preceding implementation form of the first aspect, the width field specifies a number of consecutive registers to read and the offset field specifies a starting address for the consecutive registers.

In a fourth implementation form of the method, according to the first aspect as such or any preceding implementation form of the first aspect, sequentially accessing the subset of registers comprises accessing voltage and current measurements stored in FIFO registers for State of Health (SOH) monitoring.

In a fifth implementation form of the method, according to the first aspect as such or any preceding implementation form of the first aspect, the isolated interface comprises differential signaling over twisted-pair wires with transformer or capacitor-based isolation barriers between voltage domains.

In a sixth implementation form of the method, according to the first aspect as such or any preceding implementation form of the first aspect, the method further comprising dynamically adjusting the width field based on operating conditions of a battery management system.

A second aspect relates to a system, comprising a microcontroller; a transceiver coupled to the microcontroller; a battery management front-end circuit; a vertical interface coupling the transceiver to the battery management front-end circuit through isolation barriers; and a register map in the battery management front-end circuit, wherein the register map is accessible through a configurable burst command, the configurable burst command comprising a width field specifying a number of consecutive registers to read and an offset field specifying a starting address for the consecutive registers.

In a first implementation form of the system, according to the second aspect as such, the system further comprising a first multiplexer providing an interface output by selecting data from the register map; and a second multiplexer configured to generate a selection control to the first multiplexer based on a burst command signal.

In a second implementation form of the system, according to the second aspect as such or any preceding implementation form of the second aspect, the second multiplexer includes a first input configured to receive a single address signal; and a second input configured to receive a burst address signal generated based on the width field and the offset field.

In a third implementation form of the system, according to the second aspect as such or any preceding implementation form of the second aspect, the register map comprises configuration registers, normal operation registers, analog-to-digital converter (ADC) measurement registers, diagnostic registers, First-In-First-Out (FIFO) registers, or a combination thereof.

In a fourth implementation form of the system, according to the second aspect as such or any preceding implementation form of the second aspect, the ADC measurement registers comprise voltage and current registers and temperature registers.

In a fifth implementation form of the system, according to the second aspect as such or any preceding implementation form of the second aspect, the transceiver is configured to translate between Serial Peripheral Interface (SPI) protocol and Vertical Interface (VIF) protocol.

In a sixth implementation form of the system, according to the second aspect as such or any preceding implementation form of the second aspect, the vertical interface comprises a positive isolation node; and a negative isolation node, wherein the positive isolation node and the negative isolation node provide differential signaling across voltage domains.

In a seventh implementation form of the system, according to the second aspect as such or any preceding implementation form of the second aspect, the configurable burst command enables access to measurement data stored in non-sequential register locations based on a sampling sequence.

A third aspect relates to an electric vehicle, comprising a battery pack including multiple cell groups; a plurality of battery management front-end circuits, each battery management front-end circuit configured to monitor a respective cell group; and a battery management system electronic control unit (ECU) coupled to each of the battery management front-end circuits through isolated vertical interfaces, the battery management system ECU including a microcontroller, and a transceiver configured to translate microcontroller commands into vertical interface protocol commands, and receive responses from the battery management front-end circuits, wherein the battery management system ECU is configured to access register data from the battery management front-end circuits using a configurable burst command that specifies a width parameter and an offset parameter for defining register subsets.

In a first implementation form of the electric vehicle, according to the third aspect as such, the battery management system ECU is configured to monitor State of Health (SOH) of the battery pack by accessing sequences of voltage and current measurements stored in First-In-First-Out (FIFO) registers using the configurable burst command.

In a second implementation form of the electric vehicle, according to the third aspect as such or any preceding implementation form of the third aspect, the battery management front-end circuits are arranged in a daisy-chain configuration through the isolated vertical interfaces.

In a third implementation form of the electric vehicle, according to the third aspect as such or any preceding implementation form of the third aspect, the configurable burst command enables the battery management system ECU to dynamically adjust the width parameter based on detected operating conditions of the battery pack.

In a fourth implementation form of the electric vehicle, according to the third aspect as such or any preceding implementation form of the third aspect, the electric vehicle further comprising a Controller Area Network (CAN) bus interface coupled to the battery management system ECU for communicating battery status information to vehicle systems.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method, comprising:
receiving, at a transceiver, a frame structure from a microcontroller, the frame structure including a header field and a data field, wherein the data field includes a width field and an offset field;
identifying, by the transceiver, a burst command through the header field;
configuring, based on the burst command, a first multiplexer to select between a single address mode and a burst mode;
generating a burst address signal based on the width field and the offset field;
sequentially accessing, through a second multiplexer, a subset of registers defined by the width field and offset field; and
transmitting data stored in the subset of registers through an isolated interface to the transceiver.

2. The method of claim 1, wherein the subset of registers includes configuration registers, normal operation registers, analog-to-digital converter (ADC) measurement registers, diagnostic registers, First-In-First-Out (FIFO) registers, or a combination thereof.

3. The method of claim 1, further comprising:
receiving multiple read answers through the isolated interface at the transceiver;
translating the multiple read answers from a first protocol to a second protocol; and
forwarding consolidated data to the microcontroller.

4. The method of claim 1, wherein the width field specifies a number of consecutive registers to read and the offset field specifies a starting address for the consecutive registers.

5. The method of claim 1, wherein sequentially accessing the subset of registers comprises accessing voltage and current measurements stored in FIFO registers for State of Health (SOH) monitoring.

6. The method of claim 1, wherein the isolated interface comprises differential signaling over twisted-pair wires with transformer or capacitor-based isolation barriers between voltage domains.

7. The method of claim 1, further comprising dynamically adjusting the width field based on operating conditions of a battery management system.

8. A system, comprising:
a microcontroller;
a transceiver coupled to the microcontroller;
a battery management front-end circuit;
a vertical interface coupling the transceiver to the battery management front-end circuit through isolation barriers; and
a register map in the battery management front-end circuit, wherein the register map is accessible through a configurable burst command, the configurable burst command comprising a width field specifying a number of consecutive registers to read and an offset field specifying a starting address for the consecutive registers.

9. The system of claim 8, further comprising:
a first multiplexer providing an interface output by selecting data from the register map; and
a second multiplexer configured to generate a selection control to the first multiplexer based on a burst command signal.

10. The system of claim 9, wherein the second multiplexer includes:
a first input configured to receive a single address signal; and
a second input configured to receive a burst address signal generated based on the width field and the offset field.

11. The system of claim 8, wherein the register map comprises configuration registers, normal operation registers, analog-to-digital converter (ADC) measurement registers, diagnostic registers, First-In-First-Out (FIFO) registers, or a combination thereof.

12. The system of claim 11, wherein the ADC measurement registers comprise voltage and current registers and temperature registers.

13. The system of claim 8, wherein the transceiver is configured to translate between Serial Peripheral Interface (SPI) protocol and Vertical Interface (VIF) protocol.

14. The system of claim 8, wherein the vertical interface comprises:
a positive isolation node; and
a negative isolation node, wherein the positive isolation node and the negative isolation node provide differential signaling across voltage domains.

15. The system of claim 8, wherein the configurable burst command enables access to measurement data stored in non-sequential register locations based on a sampling sequence.

16. An electric vehicle, comprising:
a battery pack including multiple cell groups;
a plurality of battery management front-end circuits, each battery management front-end circuit configured to monitor a respective cell group; and
a battery management system electronic control unit (ECU) coupled to each of the battery management front-end circuits through isolated vertical interfaces, the battery management system ECU including:
a microcontroller, and
a transceiver configured to:
translate microcontroller commands into vertical interface protocol commands, and
receive responses from the battery management front-end circuits,
wherein the battery management system ECU is configured to access register data from the battery management front-end circuits using a configurable burst command that specifies a width parameter and an offset parameter for defining register subsets.

17. The electric vehicle of claim 16, wherein the battery management system ECU is configured to monitor State of Health (SOH) of the battery pack by accessing sequences of voltage and current measurements stored in First-In-First-Out (FIFO) registers using the configurable burst command.

18. The electric vehicle of claim 16, wherein the battery management front-end circuits are arranged in a daisy-chain configuration through the isolated vertical interfaces.

19. The electric vehicle of claim 16, wherein the configurable burst command enables the battery management system ECU to dynamically adjust the width parameter based on detected operating conditions of the battery pack.

20. The electric vehicle of claim 16, further comprising a Controller Area Network (CAN) bus interface coupled to the battery management system ECU for communicating battery status information to vehicle systems.
